(19) United States
(12) Patent Application Publication
(10) Pub. No.: US 2006/0042410 A1
(43) Pub. Date: Mar. 2, 2006

(54) Humidity sensor protective shield

(75) Inventors: Malath Ibrahim Arar, Clifton Park, NY (US); Mofeez Murtaza, Niskayuna, NY (US); Michael John Barno, Ballston Spa, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/931,976

(22) Filed: Sep. 2, 2004

(51) Int. Cl. G01P 1/02; G01L 19/14

(52) U.S. Cl. 73/866.5; 73/431

(57) ABSTRACT

A shield for a humidity sensor probe includes a hollow enclosure substantially covering the humidity sensor probe, the hollow enclosure having a peripheral wall and a forward end wall, the peripheral wall secured to a rearward flange adapted for securement to a humidity sensor housing; wherein the peripheral wall is provided with a plurality of flow apertures.

### BACKGROUND OF THE INVENTION

This invention relates to humidity sensors and specifically, to humidity sensors that are used in the inlet sections to gas turbines.

Humidity sensors in gas turbine inlets are subjected to extreme weather conditions, ranging from dry air to saturated air at high air speeds. Under extreme wet conditions, the humidity sensor loses accuracy and speed of response due to saturation and slow recovery. The structural integrity of the humidity sensor under high speed air flow in the gas turbine inlet ducting is also of concern. To ensure optimum performance of modern gas turbine engines, it is important that real time measurements be as accurate as possible. In this regard, a fast response time, within two minutes, along with accuracy of measurement, within plus or minus 1° Celsius, is required along with structural integrity in a high air flow speed environment.

### BRIEF DESCRIPTION OF THE INVENTION

In accordance with an exemplary embodiment of this invention, a humidity sensor enclosure has been designed to protect and improve humidity sensor responsiveness. Specifically, the enclosure may take the form of a cylindrical shield that substantially encloses the humidity sensor, with a plurality of air flow holes or perforations axially extending along the top of the shield, with a similar plurality of holes located along the bottom of the shield, but slightly circumferentially offset from the upper holes. A ventilation hole is provided in the forward end of the shield, and if desired, one or more drain holes may be provided near the rearward end of the shield. The shield itself is welded to a flange that is, in turn, bolted to the humidity sensor electronic box.

The holes on both the top and bottom of the shield are offset so that excessive water will not impinge directly on the sensor head. The ventilation hole at the forward end of the shield is designed to prevent water retention in the shield, hence improving ventilation and sensor responsiveness. It also prevents sensor malfunction due to saturation.

Accordingly, in its broader aspects, the present invention relates to a shield for a humidity sensor probe comprising a hollow enclosure substantially covering the humidity sensor probe, the hollow enclosure having a peripheral wall and a forward end wall, the peripheral wall secured to a rearward flange adapted for securement to a humidity sensor housing; wherein the peripheral wall is provided with a plurality of flow apertures.

In another aspect, the present invention relates to a shield for a humidity sensor probe comprising a hollow enclosure substantially covering the humidity sensor probe, the hollow enclosure having a peripheral wall and a forward end wall, the peripheral wall secured to a rearward flange adapted for securement to a humidity sensor housing; wherein the peripheral wall is provided with a plurality of flow apertures; wherein the hollow enclosure is substantially cylindrical in shape, and is arranged concentrically over the sensor probe; and wherein the plurality of flow apertures comprises a first group of apertures arranged along the peripheral wall and a second group of apertures arranged along the peripheral wall, circumferentially offset from the first group of apertures.

The invention will now be described in connection with the drawings identified below.

### BRIEF DESCRIPTION OF THE DRAWINGS

FIG. 1 is a perspective view of a humidity sensor projecting into a gas turbine inlet;

FIG. 2 is a perspective view of a humidity sensor shield in accordance with a first exemplary embodiment of the invention;

FIG. 3 is a cross section of the shield and humidity sensor of FIG. 2; and

FIG. 4 is a cross section taken along the line 4-4 of FIG. 3.

### DETAILED DESCRIPTION OF THE INVENTION

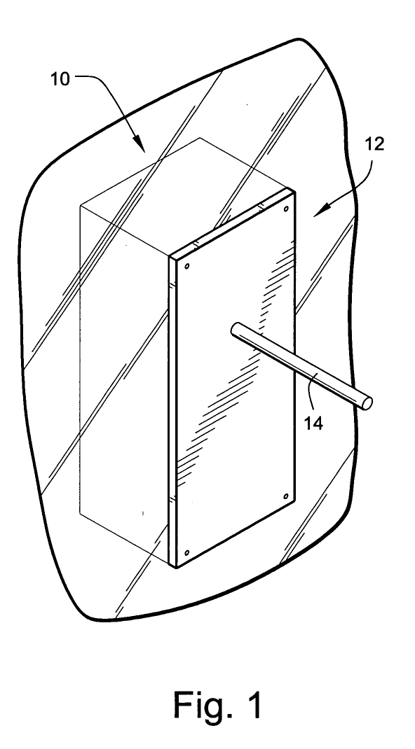

With reference to FIG. 1, the gas turbine inlet is shown generally at 10 and a humidity sensor 12 is secured to the exterior surface of the inlet wall, with a sensor probe 14 projecting into the flow path at a substantially 90° angle relative to the flow. Because the sensor probe 14 is exposed directly to the flow, the sensor performance is adversely effected by water saturation leading to failures in systems depending on humidity measurements.

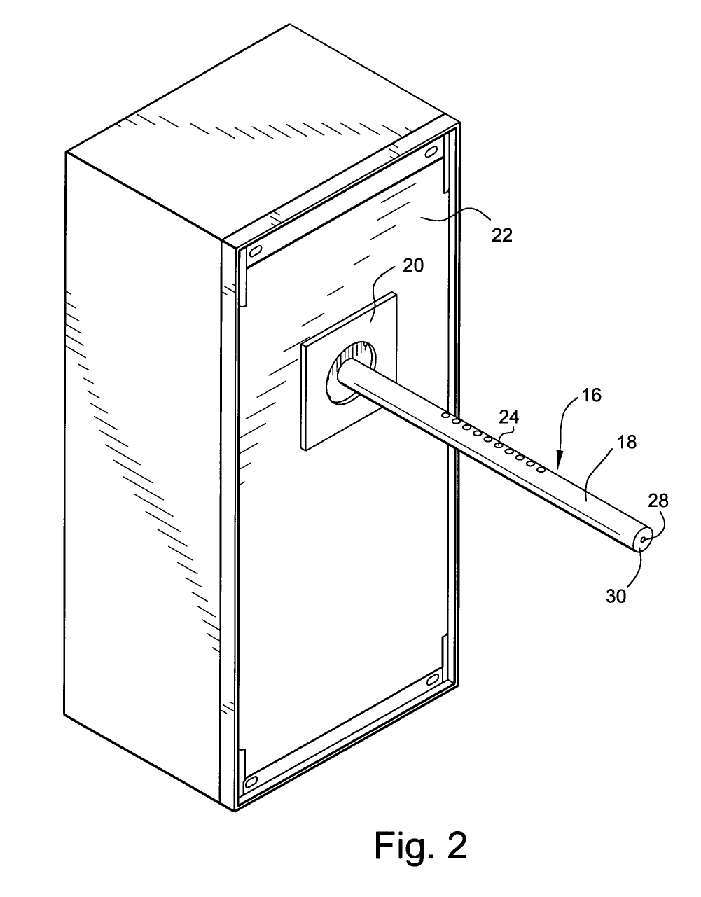

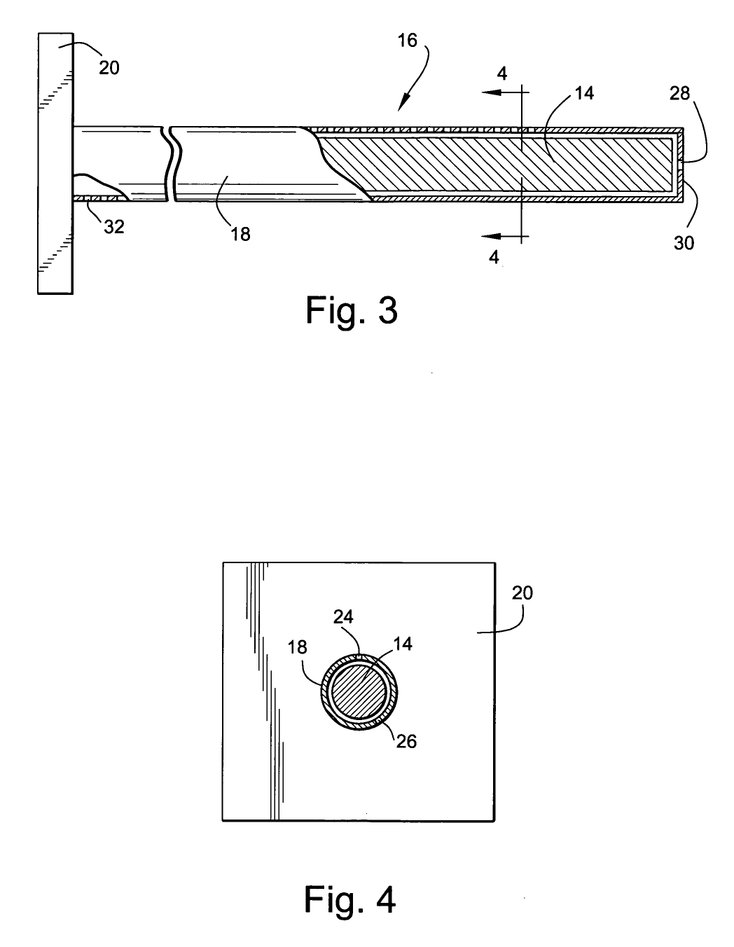

FIGS. 2-4 illustrate a humidity sensor shield in accordance with an exemplary embodiment of the invention. Specifically, the shield 16 may include a substantially cylindrical enclosure 18 fixed to a flange 20 at the rearward end thereof. The shield and flange may then be bolted directly to the humidity sensor electronic box 22. The sensor enclosure 18 is preferably constructed of stainless steel and is of substantially cylindrical shape, although other shapes may be employed. The enclosure is sized to enclose the sensor in a substantially concentric arrangement, with radial space between the sensor and the peripheral wall of the enclosure as best seen in FIG. 3. A first plurality of flow holes or apertures 24 is formed in an axially spaced array, along the top (i.e., 12 o'clock position) of the enclosure, approximately midway along the length of the enclosure. A second plurality of flow holes or apertures 26 is provided similar array, along the bottom of the enclosure (approximately at the 6 o'clock position), but offset circumferentially so that the holes 24 and 26 are not directly aligned in the flow direction. A ventilation hole 28 is formed in the end wall 30 of the enclosure and one or more drain holes 32 may be provided in the enclosure close to the flange 20, along the bottom of the enclosure.

In one particular application, the enclosure may have a length dimension of about 385 mm, with an outside diameter of about 22 mm and an inside diameter of about 18 mm. The holes 24 and 26 may have diameters of about 6 mm, and the end hole 28 may have a diameter of about 2 mm. Of course, the dimensions of the enclosure may vary with the size of the humidity sensor.

The 6 mm holes 24 and 26 are offset so that excessive water will not impinge directly on the sensor head, and the 2 mm hole in the end 30 is designed to prevent water retention in the shield, hence improving ventilation and sensor responsiveness. The enclosure is designed for a Strouhal Number of 0.22 for vortex shedding in a high air flow medium. The Strouhal Number is a dimensionless value useful for analyzing oscillating, unsteady fluid flow problems. The Strouhal number (Sr) is often given as: Sr=ƒ×D/V where ƒ is the frequency of vortex shedding, D is the hydraulic diameter of the object in the fluid flow and V is the velocity of the fluid. Thus, the number Sr represents a measure of the ratio of inertial forces due to the unsteadiness of the flow or acceleration of the inertial forces due to changes in velocity from one point to another in the flow.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A shield for a humidity sensor probe comprising a hollow enclosure substantially covering the humidity sensor probe, said hollow enclosure having a peripheral wall and a forward end wall, said peripheral wall secured to a rearward flange adapted for securement to a humidity sensor housing; wherein said peripheral wall is provided with a plurality of flow apertures.

2. The shield of claim 1 wherein said plurality of flow apertures comprises a first group of apertures arranged along said peripheral wall and a second group of apertures arranged along said peripheral wall, circumferentially offset from said first group of apertures.

3. The shield of claim 2 wherein said first and second groups of apertures are not diametrically opposed.

4. The shield of claim 2 wherein said hollow enclosure is substantially cylindrical in shape, and is adapted to be arranged concentrically over the sensor probe.

5. The shield of claim 4 wherein said first group of apertures is arranged axially along the peripheral wall, perpendicular to a direction of flow past the humidity sensor probe.

6. The shield of claim 5 wherein said second group of apertures is arranged axially along the peripheral wall in a downstream and almost diametrically opposed relation to said first group of apertures.

7. The shield of claim 1 and further comprising a ventilation aperture in said forward end wall.

8. The shield of claim 7 wherein said plurality of flow apertures have a diameter of about 6 mm, and said ventilation aperture has a diameter of about 2 mm.

9. The shield of claim 1 wherein said hollow enclosure is constructed of stainless steel.

10. The shield of claim 2 wherein said first and second groups of apertures are located approximately midway along a length dimension of the probe.

11. The shield of claim 1 wherein said hollow enclosure is designed to have a Strouhal Number of 0.22.

12. A shield for a humidity sensor probe comprising a hollow enclosure substantially covering the humidity sensor probe, said hollow enclosure having a peripheral wall and a forward end wall, said peripheral wall secured to a rearward flange adapted for securement to a humidity sensor housing; wherein said peripheral wall is provided with a plurality of flow apertures; wherein said hollow enclosure is substantially cylindrical in shape, and is adapted to be arranged concentrically over the sensor probe; and wherein said plurality of flow apertures comprises a first group of apertures arranged along said peripheral wall and a second group of apertures arranged along said peripheral wall, circumferentially offset from said first group of apertures.

13. The shield of claim 12 wherein said hollow enclosure is designed to have a Strouhal Number of 0.22.

14. The shield of claim 12 wherein said hollow enclosure is constructed of stainless steel.

15. The shield of claim 12 and further comprising at least one ventilation aperture in said forward end wall.

16. The shield of claim 15 wherein said plurality of flow apertures have a diameter of about 6 mm, and said ventilation aperture has a diameter of about 2 mm.
